(19) United States
(12) Patent Application Publication
(10) Pub. No.: US 2024/0405443 A1
(43) Pub. Date: Dec. 5, 2024

(54) MEMBRANE FOR AN ANTENNA

(71) Applicant: SCIENTEAMA, HEROUVILLE-SAINT-CLAIR (FR)

(72) Inventors: Benoit Agnus, Villons Les Buissons (FR); Stephane CARRAS, Conde Sur Noireau (FR)

(73) Assignee: SCIENTEAMA, HEROUVILLE-SAINT-CLAIR (FR)

(21) Appl. No.: 18/713,295

(22) PCT Filed: Dec. 7, 2022
(86) PCT No.: PCT/EP2022/084695

§ 371 Date: May 24, 2024

(30) Foreign Application Priority Data
Dec. 29, 2021 (FR) FR2114630
Dec. 29, 2021 (FR) FR2114631

(51) Int. Cl. H01Q 19/10; H01Q 1/36

(52) U.S. Cl. CPC H01Q 19/104; H01Q 1/36

(57) ABSTRACT

The invention relates to an elastic membrane (1) for an antenna (2), the membrane comprising an entanglement of one or more nonwoven conductive wire(s) secured in a matrix of an elastic material.

### TECHNICAL FIELD OF THE INVENTION

The present invention generally relates to antennas, and in particular to radio frequency antennas.

### TECHNICAL BACKGROUND

An antenna is a device for radiating (transmitter) or receiving (receiver) electromagnetic waves. The antenna is a key element in a radio system. It is characterized in particular by its efficiency, gain, and radiation pattern. These parameters directly influence the quality and range performance of the system.

For microwaves, reflector antennas are known in particular. These antennas may in particular use planar or parabolic reflectors.

The parabolic antenna is most well-known for its use in satellite television or for space applications.

The parabolic (dish) antenna conventionally includes a parabolic reflector that is responsible for concentrating waves received or transmitted to an antenna source. Conventionally, the source is placed in the focal point of the dish.

The source may be a transmitter in the case of an antenna used for transmission, or a receiver in the case of an antenna used for reception.

There are also planar antennas that include a radiating element in the form of a planar sheet that can take the form of a rectangle, square, or banner.

In the field of space, the weight and size of the antenna are paramount and especially during the launch of a satellite, a space vehicle or any other object. Thus, deployable antennas were developed. Some use rigid folding petals that can be deployed to form a parabolic or planar antenna. However, this type of antenna has the disadvantages of being cumbersome and complex to manufacture and implement (which leads to increased risks of failure). Other deployable antenna technologies implement a foldable metal network or metalized plastic film.

The drawbacks of these technologies remain the weight and the risk of failure due to the complexity of their mode of operation.

### SUMMARY OF THE INVENTION

Based on this problem, the present invention therefore aims to develop a new technology making it possible to produce antennas that are lighter. Another objective of the present invention is to obtain antennas that are less bulky. Another objective of the present invention is to obtain antennas that are less expensive and simpler to implement. Another objective of the present invention is to produce antennas that are more reliable.

In particular, the invention relates to an elastic membrane for an antenna, the membrane comprising an entanglement of one or more nonwoven conductive wire(s) secured in a matrix of an elastic material. In the context of the present invention, by entanglement we mean any consolidation or grouping or entanglement or intertwining of at least one wire(s).

In the context of the present invention, wire is understood to mean an element with a longitudinally extended shape. For example, a ribbon (or a long rectangle) must also be considered to be a wire within the meaning of the present invention. A wire can have any diameter, even a large diameter, such as a string or a cylinder.

Advantageously, at least one of the one or more conductor wires of the entanglement is a wire comprising a first strand made of electrically conductive material and a second strand made of deformable thermoformable material, said first and second strands being intertwined. Of course, the thermoformable material can be rigid or even elastic.

Advantageously, the thermoformable material is silicone.

Advantageously, the matrix is obtained from the thermoformable material of the second strand.

Advantageously, the intertwining of the first and second strands is obtained by braiding. Of course, the intertwining may be obtained by any other technique of wrapping of strands or wires such as, for example, weaving, knitting or by at least partially melting or fusing at least one of the strands.

According to one embodiment of the present invention, the membrane is a deployable membrane for an antenna that can take a first folded state (or collapsed or compressed or crumpled or otherwise space-saving) in which the membrane size is reduced and a second expanded state (or unfolded or decompressed or opened out or larger in size) in which the membrane has optimal geometry for the antenna.

According to the invention, the membrane can comprise at least one arm secured to the membrane, said arm comprising a shape memory material.

According to one embodiment of the invention, at least one of the one or more arms comprises a wire comprising a first strand made of shape memory material and a second strand made of electrically conductive material, said second strand being wound around the first strand.

According to at least one embodiment of the invention, at least one of the one or more arms comprises a wire produced from an alloy of a shape memory material and an electrically conductive material.

According to one embodiment of the invention, the membrane is parabolic in shape in the expanded state and comprises several arms attached to the inner surface of the dish and extending from the center of the dish to the periphery of the dish when in the expanded state.

According to one embodiment of the invention, the membrane has a banner shape in the deployed state and comprises at least one arm secured parallel to the banner when in the deployed state.

The invention also relates to a reflector antenna whose reflector comprises a membrane as previously described.

The invention also relates to a planar antenna comprising a radiating panel which itself comprises a membrane as described above.

According to one embodiment of the present invention, the membrane is a deployable membrane for an antenna that can take on a first collapsed state (or folded or compressed or crumpled or otherwise space-saving) wherein the membrane size is reduced, and a second deployed state (or unfolded or decompressed or opened out or larger in size) wherein the membrane has optimal geometry for the antenna.

According to the invention, the membrane can comprise at least one arm secured to the membrane, said arm comprising a shape memory material. In the context of the present invention, secured is understood to mean securing directly or indirectly (for example, connected via another element). In the context of the present invention, shape-memory material is understood to mean any material that, once deformed, is at least partially capable of resuming a shape, a size, a geometry or a configuration under certain conditions. A material with shape reversibility or material in a reversible state is also to be considered as a shape memory material according to the invention.

Thus, according to one embodiment of the invention, the deployment of the membrane may be activated by an internal action or an external action, for example thermal heating.

Advantageously, at least one of the one or more arms comprises a wire comprising a first strand made of shape memory material and a second strand made of electrically conductive material, said second strand being wound around the first strand. According to one embodiment of the invention, at least one arm comprises an assembly of at least two components: one component based on a reversible state of shape material and another component based on another material that is electrically conductive. For example, if the arm is a wire, it may be the assembly of wires fulfilling these functions.

Advantageously, at least one of the one or more arms comprises a wire produced from an alloy of a shape memory material and an electrically conductive material. According to one embodiment of the invention, the electrically conductive material is such that, due to its physicochemical properties, it allows thermal heating.

Advantageously, the membrane has a parabolic shape in the expanded state and comprises several arms secured to the inner surface of the dish and extending from the center of the dish to the periphery of the dish when in the expanded state. Advantageously, the membrane has a banner shape in the deployed state and comprises at least one arm secured parallel to the banner when in the deployed state.

Advantageously, the membrane is an elastic membrane.

According to one embodiment of the invention, the membrane comprises an entanglement of one or more nonwoven conductive wire(s) secured in a matrix of an elastic material.

Advantageously, at least one of the one or more conductor wires of the entanglement is a wire comprising a first strand made of electrically conductive material and a second strand made of deformable thermoformable material, said first and second strands being intertwined. Of course, the thermoformable material can be rigid or even elastic.

Advantageously, the thermoformable material is silicone.

Advantageously, the matrix is obtained from the thermoformable material of the second strand.

Advantageously, the intertwining of the first and second strands is obtained by braiding. Of course, the intertwining may be obtained by any other technique of wrapping of strands or wires such as, for example, weaving, knitting or by at least partially melting or fusing at least one of the strands.

The invention also relates to a reflector antenna comprising a reflector comprising a membrane as previously described.

The invention also relates to a planar antenna comprising a radiating panel comprising a membrane as previously described.

The invention further relates to a method for manufacturing an antenna reflector, in particular an antenna reflector a membrane according to the invention as described above. The invention also relates to a method for manufacturing an antenna comprising such a reflector.

The invention further relates to a method for manufacturing a radiating panel for a planar antenna, and in particular a radiating panel comprising a membrane according to the invention as described above.

### BRIEF DESCRIPTION OF THE FIGURES

Other features and advantages of the invention will become apparent from the following detailed description, which will be understood by referring to the appended drawings in which:

FIG. 1 schematically and in an isometric view, shows an exemplary embodiment of a membrane according to the invention;

FIG. 2 schematically shows a reflector antenna according to an exemplary embodiment of the invention;

FIG. 3 schematically shows a reflector antenna deployable according to an exemplary embodiment of the invention.

### DETAILED DESCRIPTION OF THE INVENTION

Different aspects of different embodiments of an antenna reflector according to the invention are described in more detail below, referring to the accompanying drawings. Functionally, the main features of an antenna include: the frequency range covered, the radiation characteristics including radiation pattern, gain, directivity, and efficiency (which is related to intrinsic losses), and impedance matching. This is often achieved by comparing the energy transmitted to the antenna and the energy reflected onto the injector by the antenna.

It should be noted that it is difficult to obtain antennas with both good performance and small dimensions. Indeed, the wavelengths of the frequency range covered by the antenna generate constraints on the size of the antenna. On the other hand, the gain of the antenna is generally also related to the dimensions of the antenna (e.g., for a reflector involving the square of the surface).

It should also be noted that the surface condition of the reflector also influences the performance of the antenna. Indeed, typically, irregularities or imperfections whose dimensions are greater than one tenth or one twentieth of the antenna's operating wavelength affect the performance of the antenna.

Other features are important when using an antenna. For example, the mass and dimensions of the antenna impact its portability or the methods of aiming.

Its mechanical characteristics and in particular its deformation in wind or any other stress generally result from a compromise in performance/mass.

Another important feature of the antenna, and especially in a space context, is its ability to be confined in order to reduce its size (especially during the launch of a satellite) when it is not in use and therefore also to be able to be deployed when it is activated (e.g., in space).

Within the context of application in a space context, among the important characteristics is the mass, the possibility of confining the antenna and deploying it, as well as its dimensions/bulkiness.

A membrane according to the present invention may be applied in any type of reflector antenna, whether for terrestrial or space application. It can be applied to a parabolic, convex, or planar antenna. It can be of any shape and of any dimensions.

The membrane of the present invention can also be applied in any type of planar antenna, whether for land application or space application. It can be applied to a planar antenna whose radiating panel has any shape (rectangle, banner, square, polygon, disc, etc.). It can be planar or three-dimensional, for example convex or concave. It can be of any shape and of any dimensions.

A membrane according to the present invention may also be applied in any other type of antenna.

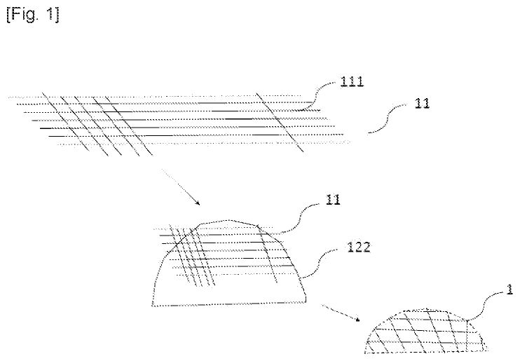

Shown in relation to FIG. 1 is an elastic membrane 1 for antenna according to a first embodiment of the invention.

In the context of the present invention, an elastic membrane or elastic material means a membrane or material that has a hardness of less than 95 A measured according to standard ASTM D2240-15. In the remainder of the description, when mentioning an A hardness value, a Shores A hardness value is understood to be measured according to standard ASTM D2240-15. According to one embodiment, a material is called elastic if it has a hardness of less than or equal to 75 A.

Thus, an elastic membrane according to the invention may be any elastic or plastic membrane, for example, having a structure with variable geometry that retains its shape integrity even when deformed by mechanical action, crumpled or folded and reversibly allowing the return to a pre-established shape by the fold-out device.

Thus, an elastic membrane according to the present invention can be, for example, a deformable membrane capable of changing from a reduced surface area to an extended surface area, while maintaining an isomorphism between the two structures. Such a membrane can be obtained by any techniques of wrapping the wires and even by the melt-bonding techniques.

In the case of change from a crumpled shape to an opened-out shape, this deployed structure may retain its integrity of shape even if deformed by mechanical action. This structure may reversibly allow the return to a crumpled shape by the fold-out device.

According to the present embodiment of the invention, the membrane 1 comprises an entanglement of one or more nonwoven conductor(s) secured in a matrix of a flexible material.

Of course, the entanglement of wire(s) may be made from a single wire or portion of wire or from multiple wires or portions of wires.

Thus, the present invention may utilize technical wires. such as wires with high electrical conductivity, for example. For example, electrical conductivity can be modulated by trying different mixtures of components. For example, structural forming materials (carbon structures, thermo-formable materials, etc.) and materials for electrical conduction (for example based on metals such as copper, silver, stainless steel, aluminum or any other metal or alloy or conductive structure) may be combined. Thus, for example, and as illustrated by FIG. 1, to obtain the membrane 1, an entanglement 11 is carried out of which at least one of the one or more leads of the entanglement is a wire 111 comprising a first strand made of an electrically conductive material and a second strand made of a deformable thermoformable material. For example, the first and second strands are intertwined. Of course, some of the wires according to the invention may comprise any number of strands (for example, a third textile strand may be added to the first and second strands in the intertwining). Certain other wires may have only one strand. According to alternatives of the present embodiment of the invention, some or all of the first and second strands may not be intertwined but only related or associated or even arranged adjacent to one another. According to other alternatives of the present embodiment of the invention, some or all of the wires comprise a first strand (core) around which the second strand forms a sheath. Within the scope of this embodiment, each of the wires used to produce the membrane comprises a first copper strand and a second silicone strand.

Of course, in accordance with the invention, any heat-meltable material or any mixture of heat-meltable materials incorporating an electrically conductive metal substrate or any other electrical conductor such as carbon, for example, may also be used.

Of course, any elastic material compatible with thermoforming could be used within the context of the present invention, such as polymers (e.g., polypropylene or “PP”), charged polymers, doped polymers, copolymers whose hardness or elasticity may be modulated, resins, ethylene vinyl acetate (EVA), polystyrene (PS), Polyethylene (PE), polypropylene (PP), polycarbonate (PC), acrylonitrile butadiene styrene (ABS), polyvinylchloride (PVC), polymethylmethacrylate (PMMA), polystyrene shock (SB), etc.

The polymers or resins can be charged with EVA in order to modulate the elasticity of the wire or strand.

The intertwining of the first and second strands in order to produce a wire may, for example, result from a braiding technique. For example, the Filix company offers such wires. It may be produced by any other technique. Alternatively, the strands can, for example, be intertwined (manually or by machine) so as to form one or more braids. Thus, the present invention, according to some variants, makes it possible to benefit from the great flexibility related to the characteristics of textile wires (when such wires or strands are used). According to certain embodiments of the invention, wires that are more or less rigid and more or less flexible or more or less stretchable may be used. According to one embodiment of the invention, the entanglement of the wire(s) may be achieved manually. For example, a user may distribute the wire(s) over a surface or in a mold 122 such that, for example, the entanglement obtained has some homogeneity. Alternatively, the entanglement can be achieved by machine. Of course, the entanglement of the wire(s) can be achieved by any material assembly technique (such as polymers, metals, etc.), whether by melting means or traditional techniques (e.g., fibril bonding, or more complex techniques of assembled wires such as braiding, are some examples thereof.

According to variants of the present invention, some of the one or more wires may be woven or knit or nonwoven over a portion or over the entire surface of the membrane.

According to one embodiment of the invention, the matrix of an elastic material is obtained for example by casting or even fusing an elastic material (for example silicone rendered liquid or at least malleable) on or within the entanglement. According to another embodiment, the matrix of elastic material may be obtained by applying heat (for example by thermoforming) to the entanglement of wire(s) 11 previously placed in a mold 122 such that the thermoformable material of the second strand(s) of the wire(s) takes the shape of the mold which is that of membrane 1 which is desired to be obtained. Optionally, a and/or mechanical pressure may be added to the entanglement of the wire(s) during thermoforming. Thus, the entanglement of nonwoven conductive wires is finally joined in a matrix of an elastic material.

The membrane may have a two-dimensional shape such as a disc or a three-dimensional shape such as a dish or any other two or three-dimensional shape as previously indicated.

Thus, in accordance with the present invention, the membrane can be shaped, for example, by thermoforming and application of mechanical pressure such as entanglement. Thus, in accordance with the present invention, the membrane may have a three-dimensional shape or structure after thermoforming.

The structure of the membrane surface can be either solid or mesh depending on the purpose of the antenna user, that is to say, openwork while respecting the constraints related to the working wavelength.

For example, such a membrane may be used as a reflector in a reflector antenna. For example, such a membrane may be used in a parabolic antenna. Such a membrane may be used, for example, as a radiating panel in a planar antenna, for example a radiating banner.

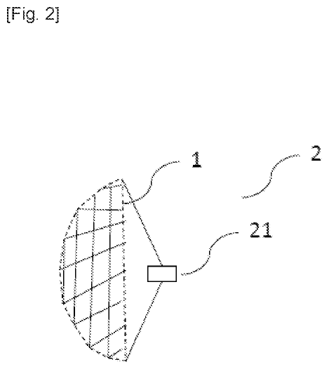

In relation to FIG. 2, a reflector antenna 2 is shown according to an exemplary embodiment of the invention.

For example, the antenna 2 is a parabolic antenna comprising a source 21 placed at the focal point of the antenna 2.

For example, the reflector is the membrane 1 previously described, which has a conductive and radiating or reflective surface of the waves due to the entanglement of conductive wire(s).

Thus, electrical and mechanical properties of the reflector (e.g., the membrane) improved via the invention can be obtained through the combining of materials.

Thus, the radiating or reflective conductive surface may be an assembly or entanglement of at least one thermoformed conductive wire(s) (e.g., associated thermoformable conductor). In accordance with the invention, the structure of the membrane may optionally be reinforced by adding at least one additional chassis member(s), e.g., at least one strand or wire, for example of thermoformable carbon(s) inserted into the entanglement.

Optionally, it is also possible to provide the membrane locally or over its entire surface with additional heating element(s) for example at least one strand or wire, for example made of electrically conductive material inserted into the entanglement(s) that allows a thermal elevation to be provided locally or over the entire surface or volume of the membrane due to the effects of Ohm's Law or the Joule effect.

The surface quality of the antenna as well as precision in its structure can be mechanically managed in order to obtain, for example, very good surface consistency by using a mold and by hot-pressing the wire structure (or entanglement) that will conform to the shape onto which it is pressed.

In at least one of its embodiments, the present invention relates to a deployable membrane for an antenna capable of taking a first folded (or collapsed or even crumpled) state in which the membrane space is reduced, and a second expanded (or unfolded or otherwise opened out) state in which the membrane has an optimal geometry for the antenna. According to one embodiment of the invention, the membrane comprises at least one arm secured to the membrane, said arm comprising a shape memory material. The membrane may include a single arm or multiple arms. The deployable membrane may be an elastic membrane of the type described above or even any other type of membrane, for example a metal foil or a metallized foil. The deployable membrane can also be made from super-elastic metal.

A deployable membrane in accordance with the present invention may be applied in any type of reflector antenna, whether for terrestrial or space application. It can be applied to a parabolic, convex, or planar antenna. It can be of any shape and of any dimensions.

The deployable membrane of the present invention can also be applied in any type of planar antenna, whether for terrestrial or space application. It can be applied to a planar antenna whose radiating panel has any shape (rectangle, banner, square, polygon, disc, etc.). It can be planar or three-dimensional, for example convex or concave. It can be of any shape and of any dimensions.

A deployable membrane in accordance with the present invention may also be applied in any other type of antenna.

According to one embodiment, at least one of the one or more arms comprises a wire comprising a first strand made of a memory-form material and a second strand made of an electrically conductive material, said second strand being wound around the first strand.

According to another embodiment of the invention, each of the one or more arms comprises a wire produced from an alloy of a shape memory material (for example allowing the deployment of the antenna to be controlled) and an electrically conductive material.

For example, a shape-memory material in accordance with the invention is a thermally-controlled shape-memory material, for example Nitinol (which is a nickel and titanium-based alloy).

According to a first embodiment of the invention, the membrane has a dish shape in the expanded state and it comprises several arms secured to the inner surface of the dish and extending from the center of the dish to the periphery of the dish when in the expanded state. The invention according to this first embodiment also relates to a reflector antenna comprising a reflector comprising the membrane.

Thus, the membrane of the dish can be mechanically folded by a user or by a machine in order to put it in the folded state. Once the membrane is in the folded state, applying electrical energy to the membrane arm(s) will, by Ohm-effect in the electrical conductor (for example, in the electrical conductor strand of the arm or in the electrical conductive material of the alloy of each arm) of each arm, generate heat that will be applied to the shape memory material (heat-activatable) of each arm. Thus, each arm will resume its equilibrium shape by changing the membrane into its deployed state (corresponding to the dish). This will therefore allow the deployment of the membrane.

According to a second embodiment of the invention, the membrane has a banner shape in the deployed state and it comprises at least one arm secured parallel to the banner when in the deployed state. The invention according to this first embodiment also relates to a planar antenna comprising a radiating panel comprising the membrane.

Thus, the membrane of the banner can be mechanically folded by a user or by machine so that it takes the folded state. Once in the folded state of the membrane, applying electrical energy to the membrane arm(s) will generate heat by the Ohm-effect in the electrical conductor (e.g., in the electrical conductor strand of the arm or in the electrical conductive material of the alloy of each arm) of each arm, that will be applied to the shape memory material (heat-activatable) of each arm. Thus, each arm will resume its equilibrium shape by changing the membrane into its deployed state (corresponding to the banner). This will therefore allow the membrane to be deployed.

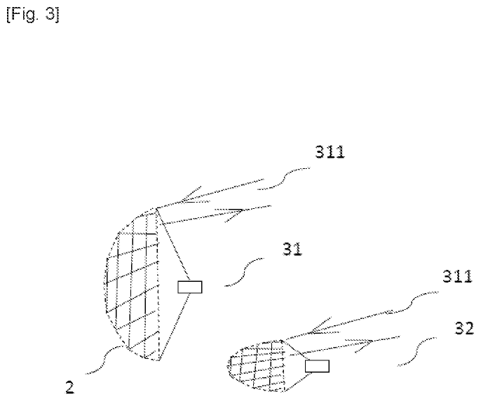

In relation to FIG. 3, a reflector antenna is shown that can be deployed according to an exemplary embodiment of the invention. For example, the antenna is the antenna 2 previously described and the reflector comprises a membrane as previously described.

The wires or other constituents of the frame structure can then be combined (for example, by producing a braid with a heat-formable multi-stranded carbon wire) with a shape memory alloy wire, making it possible to produce a wire structure of varying conductivity and therefore associating electrical conduction.

The present invention allows the combining of wires or strands with various functions such as shape memory by using, for example, shape memory alloy wires that are controllable, for example, by thermal effect.

Thus, in some membranes according to the invention, the Ohm's law characteristics make it possible to ensure electrical control of the deployment of the antenna membrane. Indeed, controlling the electrical energy 311 supplied to the electrically conductive strand or electrically conductive material of the alloy of the one or more arms (including a shape memory material) makes it possible to locally create a thermal release by Ohm's law and thereby activate the deployment of the one or more arms (and therefore the membrane and therefore the antenna) from a collapsed state 32 to a deployed state 31.

Within the context of the present invention, an electrical conductivity may be selected that is amenable to an action on the mixtures of constituents and a mix of structural forming materials (carbon structures, thermo-formable materials) and conductive materials (for example, metal-based materials such as copper, silver, stainless steel, aluminum or the like). Indeed, in some cases, it may be advantageous to reduce the conductivity in order to increase the Joule effect by greater heat dissipation.

In the case of a reflector type or radiating surface antenna structure, the unfolding (or folding) sub-functionality can be ensured by, in particular, the following effects:
i) the natural tendency to take on the shape initiated during thermoformation and creation by the flexibility and constitution of the structure (for example with carbon frames on a reflector providing stability to the mechanical structure);
ii) the distribution of the wire structure described above which exerts, during temperature rise by the Joule effect and Ohm's law, a controlled and pre-calculated mechanical action to achieve, by action of the shape memory, the intended configuration (reflector folded, unfolded, radiating banner wound, unwound or the like). Thus, in at least one of its embodiments, the present invention enables the use of entanglement of nonwoven materials or wires but assembled by thermoforming and mechanical pressure, with a combination of electrical and physicochemical conductive properties mixing multiple materials or wires forming a membrane with conductive or radiating surface to produce deformable antennas or banner-like antennas with focusing by reflector and source carried out with this same approach.

In at least one of its embodiments, the present invention thus enables the production of unfoldable or refoldable reflector-like antennas using in its structure combinations of form-memory wires and conductive wires, for example heat-dissipating wires, thus producing a wire to enable a change from the folded to the unfolded configuration, or vice versa, under the action of electrical power.

The present invention thus allows, in at least one of its embodiments, the production of radiating, unfoldable or refoldable banner-like antennas using, in its structure combinations of form-memory wires and conductive wires, for example heat-dissipation, thereby producing a wire to enable a change from the folded to the unfolded configuration or vice versa, under the action of electrical power.

The present invention thus allows, in at least one of its embodiments, the use of a shape memory material in a deployable antenna reflector to actuate the deployment or refolding of the reflector.

The present invention thus allows, in at least one of its embodiments, the use of a shape memory material in a deployable radiating banner-like antenna to actuate the deployment or refolding of the banner.

The invention also relates to a reflector antenna whose reflector comprises a membrane as previously described.

The invention also relates to a planar antenna comprising a radiating panel which itself comprises a membrane as described above.

The invention further relates to a method for manufacturing a reflector for an antenna, in particular a reflector for an antenna having a membrane according to the invention as described above. The invention also relates to a method for manufacturing an antenna comprising such a reflector.

The invention further relates to a method for manufacturing a radiating panel for a planar antenna, and in particular a radiating panel comprising a membrane according to the invention as described above.

### LIST OF REFERENCE NUMBERS

1 membrane
11 entanglement of wires
111 wire
122 mold
2 antenna
21 source
31 deployed state
32 folded state
311 electrical power

1. An elastic membrane (1) for an antenna (2) characterized in that it comprises an entanglement (11) of one or more nonwoven conductive wire(s) secured in a matrix of an elastic material.

2. The elastic membrane (1) according to claim 1, characterized in that at least one of the one or more entanglement conductors is a wire (111) comprising a first strand made of electrically conductive material and a second strand made of deformable thermoformable material, said first and second strands being intertwined.

3. The elastic membrane (1) according to claim 2, characterized in that the thermoformable material is silicone.

4. The elastic membrane (1) according to claim 2, characterized in that the matrix is obtained from the thermoformable material of the second strand.

5. The elastic membrane (1) according to claim 2, characterized in that the intertwining of the first and second strands is obtained by braiding.

6. The membrane (1) according to claim 1, characterized in that it is a deployable membrane for an antenna (2) capable of taking a first folded state (32) wherein the membrane space is reduced and a second extended state (31) wherein the membrane has optimal geometry for the antenna, and in that it comprises at least one arm secured to the membrane, said arm comprising a shape memory material.

7. The membrane (1) according to claim 6, characterized in that at least one of the one or more arms comprises a wire comprising a first strand made of a memory-form material and a second strand made of an electrically conductive material, said second strand being wound around the first strand.

8. The membrane (1) according to claim 6, characterized in that at least one of the one or more arms comprises a wire produced from an alloy of a shape memory material and an electrically conductive material.

9. The membrane (1) according to claim 6, characterized in that the membrane has a dish shape in the deployed state and comprises several arms secured to the inner surface of the dish and extending from the center of the dish to the periphery of the dish when in the deployed state.

10. The membrane (1) according to claim 6, characterized in that the membrane has a banner shape in the deployed state and comprises at least one arm secured parallel to the banner when in the deployed state.

11. A reflector antenna (2) characterized in that it comprises a reflector comprising a membrane (1) according to claim 1.

12. A planar antenna characterized in that it comprises a radiating panel comprising a membrane according to claim 1.
